(19) United States
(12) Patent Application Publication
(10) Pub. No.: US 2015/0164727 A1
(43) Pub. Date: Jun. 18, 2015

(54) Supporting Pillow Apparatus for Relieving Pressure on Buttocks

(71) Applicant: Maria Luisa LOPEZ, North Hollywood, CA (US)

(72) Inventor: Maria Luisa LOPEZ, North Hollywood, CA (US)

(21) Appl. No.: 14/107,897

(22) Filed: Dec. 16, 2013

(51) Int. Cl. A61G 13/12

(52) U.S. Cl. CPC A61G 13/1245

(57) ABSTRACT

A supporting pillow that relieves pressure on the buttocks by instead placing pressure on the thigh area when a user is in a sitting position includes a base panel, a front wall, a back wall, a left lateral wall, a right lateral wall, and a top panel. The front wall, the left lateral wall, the right lateral wall, and the back wall are perpendicularly connected with the base panel and the top panel, creating the supporting pillow. A height of the front wall is smaller than the height of back wall, where the height difference creates an incline top panel. A left leg section and a right leg section of the top panel respectively provide surface area to the left leg and right leg of the user as the user sits on the supporting pillow.

The current application claims a priority to the U.S. Provisional Patent application Ser. No. 61/857,946 filed on Jul. 24, 2013.

### FIELD OF THE INVENTION

The present invention relates generally to support pillows. More specifically, the present invention is a support pillow for relieving pressure on the buttocks when in a sitting position by instead placing pressure on the thighs. The present invention is primarily intended for use in the aftermath of buttock augmentation surgery.

### BACKGROUND OF THE INVENTION

Buttock augmentation surgery is a type of plastic surgery that involves the reshaping and enhancement of the buttocks and gluteal region of the body. Fat grafting is an integral aspect of the surgery process in which fat is harvested from other areas of the body through liposuction and then injected into the desired region of enhancement. Buttock augmentation surgery can be performed for medical reasons or purely for cosmetic enhancement. Although the surgery is often successful in achieving an overall improvement in the appearance of the buttocks, the post-operation period is often difficult. This is due to the fact that pressure must not be placed on the surgery region, typically for a few weeks. Pressure placed on the injected fat in the enhanced region of the buttocks can potentially cause the fat to die and the patient to lose fat volume in the region. This is particularly problematic due to the nature of buttock augmentation surgery as the most obvious consequence is the inability for the patient to sit properly on his or her buttocks. The problem is exacerbated by the fact that it has become increasingly common for individuals to remain seated for extended periods of time throughout a workday. A common, albeit ineffective, solution is to place various objects such as rolled yoga mats, boppy (nursing) pillows, normal head pillows, donut pillows, and yoga blocks underneath the surgery region when sitting. These solutions are ineffective as they often result in uncomfortable seating or the buttocks sinking into the objects. The present invention seeks to address the aforementioned issues and provide users with an effective, safe, discreet, and comfortable solution as the present invention can be conveniently placed on most chairs and easily carried out anywhere by the users.

The present invention is a support pillow that has been designed for use specifically during post buttock augmentation surgery. In its preferred embodiment, the present invention comprises an elongated pillow with a base panel and top panel. The base panel of the pillow is flat to allow use of the pillow on a surface such as a chair, sofa, or any location that requires the user to sit. The top panel of the pillow features a slight slope. The front portion of the pillow is positioned at a slightly lower elevation than the rear portion of the pillow. The support pillow is positioned under the user's thighs and extends the buttocks from the rear portion of the pillow. As a result, the buttocks remain elevated above the seating surface. This provides sufficient support for the user's buttocks without exerting any pressure on the buttocks region as all pressure from the support pillow is directed to the thighs. The sloped top panel of the support pillow positions the user's legs in a forward and downward position for comfort while seated. This provides stability for the user's body with the buttocks extending from the rear portion of the support pillow. The support pillow is uniformly composed of hard foam that provides comfort without causing the user to sink while he or she is sitting on the pillow. This allows a buttock augmentation surgery patient to sit in a relatively normal position for extended periods of time in the aftermath of the procedure.

The object of the present invention is to provide a means for buttock augmentation surgery patients to sit normally without applying pressure to the surgery region. The support pillow is safe and effective as pressure is not placed on the buttocks region but rather on the patient's thighs.

### BRIEF DESCRIPTION OF THE DRAWINGS

FIG. 1 is a top perspective view of the preferred embodiment of the present invention.

FIG. 2 is a bottom perspective view of the preferred embodiment of the present invention.

FIG. 3 is a front view of the preferred embodiment of the present invention.

FIG. 4 is a back view of the preferred embodiment of the present invention.

FIG. 5 is a left side view of the preferred embodiment of the present invention.

FIG. 6 is a right side view of the preferred embodiment of the present invention.

FIG. 7 is a perspective view of the alternative embodiment of the present invention.

### DETAIL DESCRIPTIONS OF THE INVENTION

All illustrations of the drawings are for the purpose of describing selected versions of the present invention and are not intended to limit the scope of the present invention.

The present invention is a support pillow for relieving pressure on the buttocks by instead placing pressure on the thigh area when in a sitting position. In its preferred embodiment, the present invention is primarily intended for use following buttock augmentation surgery as pressure placed on injected fat can potentially kill the fat and cause loss of fat volume in the enhanced region. The present invention positions underneath the user's thighs and allows the user's buttocks to extend beyond the present invention and remain elevated above the seating surface so that the present invention is able to provide a means of relieving pressure on the user's buttocks while allowing the user to sit in a normal position. However, the present invention may be used in additional applications beyond the previously mentioned buttock augmentation surgery patients.

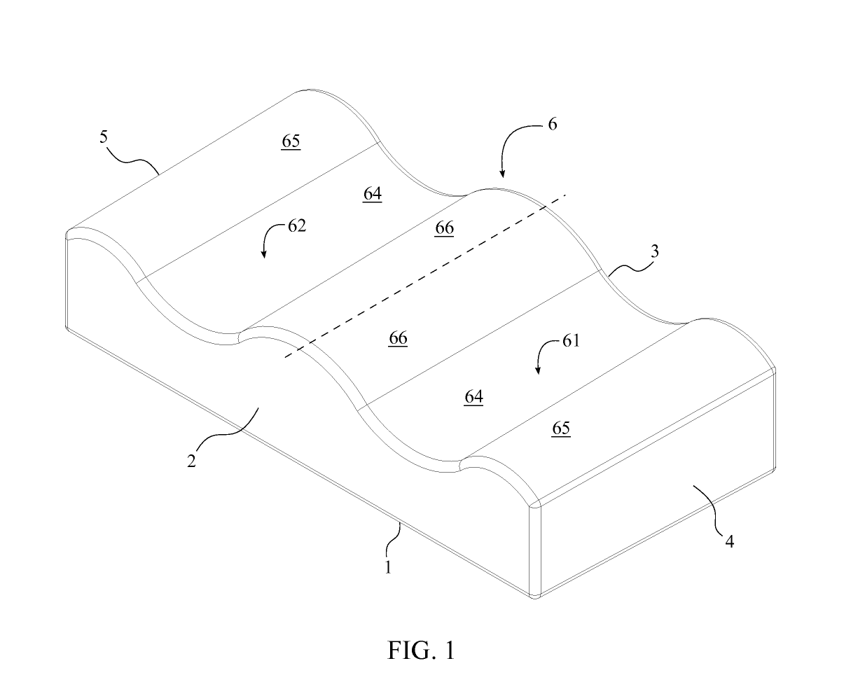

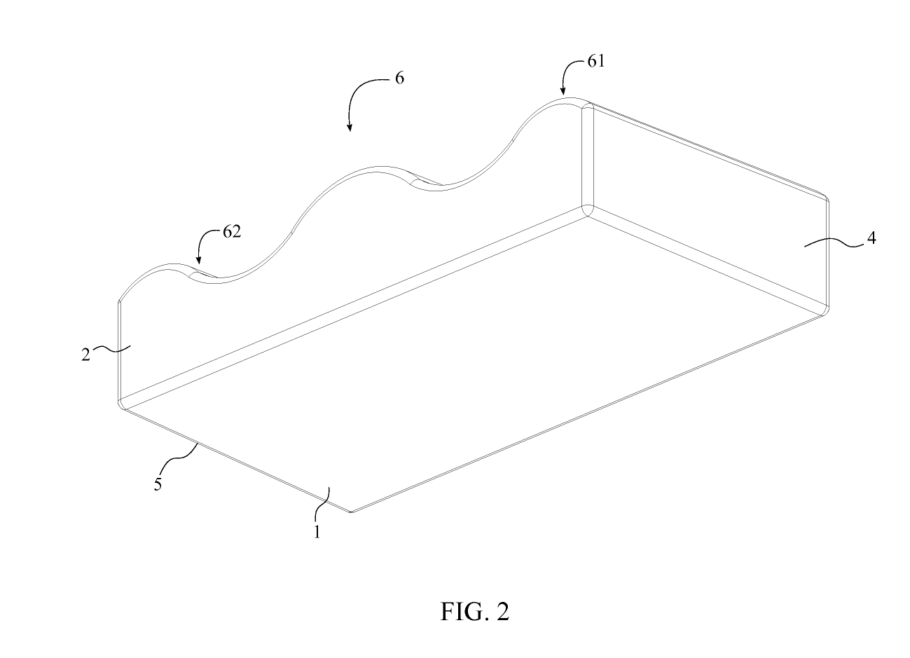

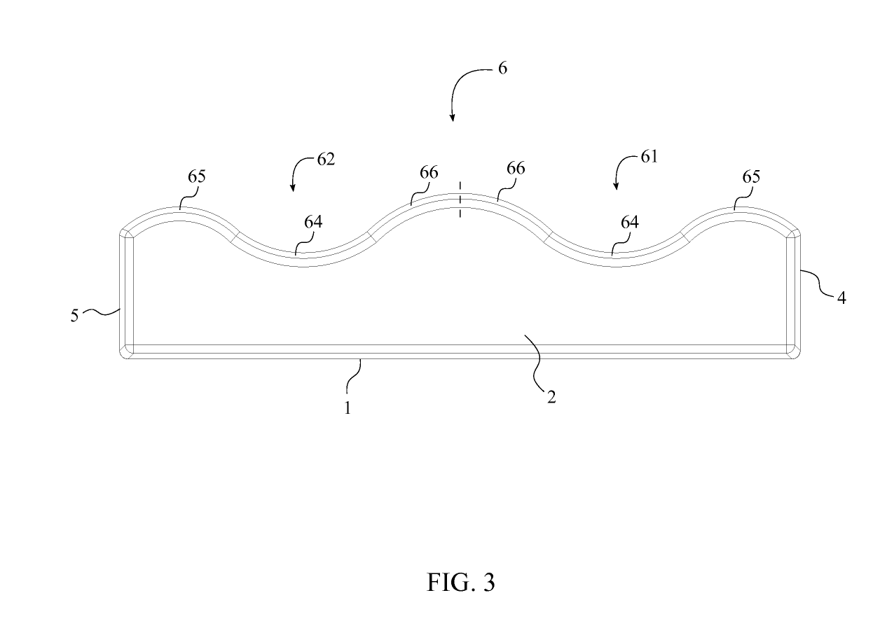

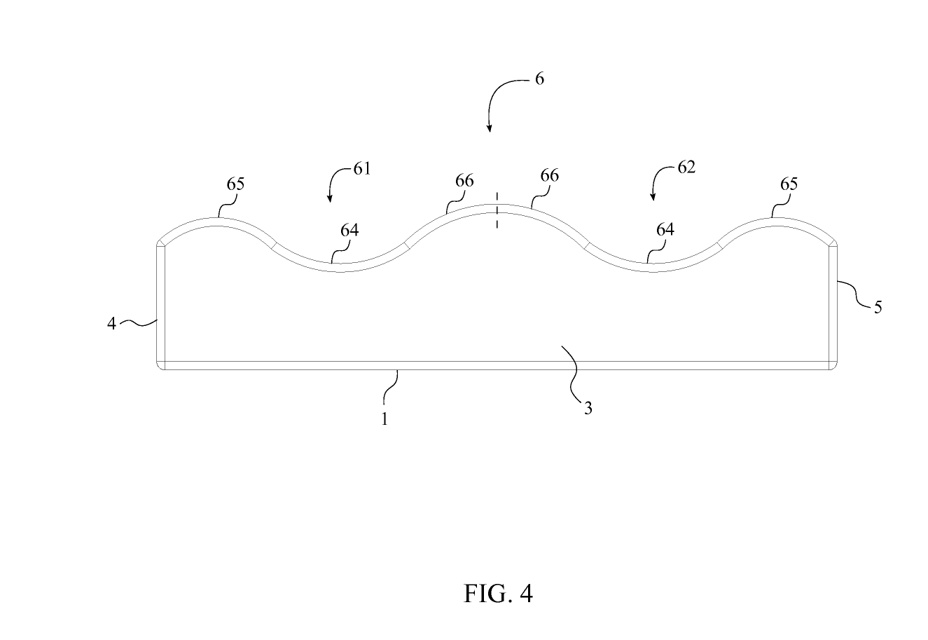

Referring to FIGS. 1-6, in the preferred embodiment of the present invention, the support pillow is a rectangular and elongated shaped pillow, where the present invention comprises a base panel 1, a front wall 2, a back wall 3, a left lateral wall 4, a right lateral wall 5, and a top panel 6. The front wall 2 is perpendicularly connected with the base panel 1, where the front wall 2 is positioned flush with the base panel 1 from the front end. The back wall 3 is perpendicularly connected with the base panel 1 and positioned flush with the base panel 1 from the back end. More specifically, the back wall 3 and the front wall 2 are oppositely positioned from each other along the base panel 1. The base panel 1 is made into a flat surface so that the flat surface can be placed on many different seating surfaces, such as chairs, sofas, and any other similar surfaces.

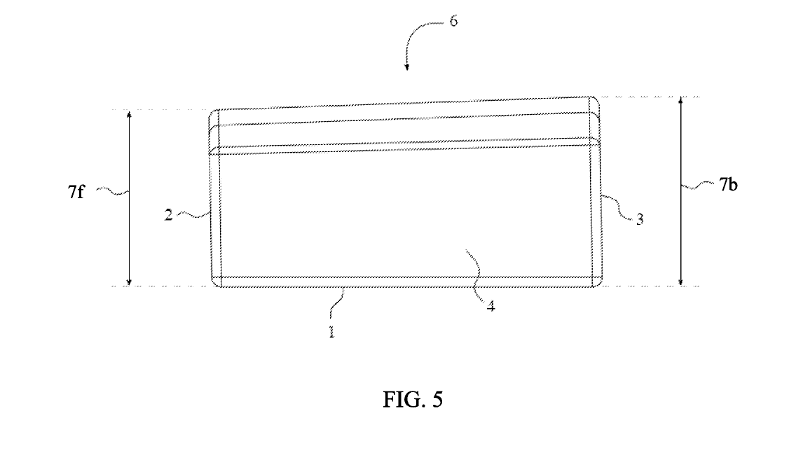

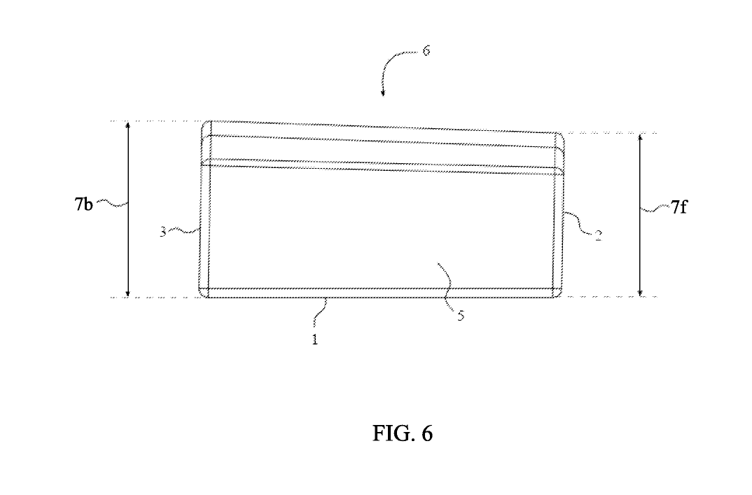

In reference to FIG. 5 and FIG. 6, the left lateral wall 4 is perpendicularly connected with the base panel 1, the front wall 2, and the back wall 3. Similarly, the right lateral wall 5 is also perpendicularly connected with the base panel 1, the front wall 2, and the back wall 3. The right lateral wall 5 and the left lateral wall 4 create the side surfaces of the present invention as the right lateral wall 5 and the left lateral wall 4 are oppositely positioned from each other across the base panel 1.

In reference to FIG. 1, the top panel 6 is perimetrically connected around the front wall 2, the left lateral wall 4, the back wall 3, and the right lateral wall 5. The top panel 6 completes the body of the present invention as the top panel 6 is oppositely positioned from the base panel 1. The connecting edges within the base panel 1, the front wall 2, the back wall 3, the left lateral wall 4, the right lateral wall 5, and the top panel 6 are made into smooth surfaces for comfort of the present invention.

In reference to FIG. 5 and FIG. 6, the front wall 2 has a height 7f and the back wall 3 has a height 7b, where the height difference between the front wall 2 and the back wall 3 directly corresponds with the slop of the top panel 6. More specifically, the height 7f for the front wall 2 is positioned from top panel 6 to the base panel 1, where the height 7f of the front wall 2 is parallel to both the left lateral wall 4 and the right lateral wall 5. Similarly, the height 7b for the back wall 3 is positioned from top panel 6 to the base panel 1 opposite from the height 7f of the front wall 2, where the height 7b of the back wall 3 is parallel to both the left lateral wall 4 and the right lateral wall 5. In the preferred embodiment of the present invention, the height 7f of the front wall 2 is smaller than the height 7b of the back wall 3 in such way that the height difference between the front wall 2 and the back wall 3 creates a slight slop within the top panel 6. The slight slop of the preferred embodiment allows the user to remain in a stable and comfortable seated position on top of the top panel 6 while the buttocks are extended beyond the back wall 3, and the legs are in a forward and downward position. As a result, the present invention prevents any pressure from being placed on the surgery region of the buttocks and instead places pressure on the user's thighs. In order to eliminate the numbness and the tingleness of the legs, a user must place the present invention within a seating surface with a proper height so that the user's feet completely touch the ground floor. Since the user's feet touch the ground, the user can comfortably and easily get up from the present invention without sliding forward. The users of the present invention also required to take breaks, walks, or stretches, if the user is sitting on the present invention for a long time so that the proper blood circulation can be maintained within the users' legs.

In reference to FIG. 1, the top panel 6 comprises a left leg section 61 and a right leg section 62, where the left leg section 61 provides surface area to rest the left leg of the user, and the right leg section 62 provides surface area to rest the right leg of the user. More specifically, the left leg section 61 and the right leg section 62 are adjacently positioned with each other in such way that the left leg section 61 is adjacently positioned with the left lateral wall 4, and the right leg section 62 is adjacently positioned with the right lateral wall 5.

In the preferred embodiment of the present invention, the left leg section 61 and the right leg section 62 each comprise a concave surface 64, an outer convex surface 65, and an inner convex surface 66. The concave surface 64, the outer convex surface 65, and the inner convex surface 66 create an indentation within the left leg section 61 and the right leg section 62 so that the legs of the user can be firmly positioned on the top panel 6. More specifically, as for the left leg section 61, the outer convex surface 65 of the left leg section 61 is adjacently positioned with the left lateral wall 4, and the concave surface 64 of the left leg section 61 is adjacently positioned with the outer convex surface 65 of the left leg section 61 opposite from the left lateral wall 4. The inner convex surface 66 of the left leg section 61 is adjacently positioned with the concave surface 64 of the left leg section 61 opposite from the outer convex surface 65 of the left leg section 61. More specifically, as for the right leg section 62, the outer convex surface 65 of the right leg section 62 is adjacently positioned with the right lateral wall 5, and the concave surface 64 of the right leg section 62 is adjacently positioned with the outer convex surface 65 of the right leg section 62 opposite from the right lateral wall 5. The inner convex surface 66 of the right leg section 62 is adjacently positioned with the concave surface 64 of the right leg section 62 opposite from the outer convex surface 65 of the right leg section 62. The inner convex surfaces 66 of the right leg section 62 and the left leg section 61 are adjacently positioned with each other completing the top panel 6. Because of the concave surfaces 64 of the left leg section 61 and the right leg section 62, the user's left leg and right leg are secured within the present invention without any kind of unnecessary lateral movements as the user's legs are positioned in between the inner convex surface 66 and the outer convex surface 65 of the left leg section 61 and the right leg section 62. The inner convex surfaces 66 of the left leg section 61 and the right leg section 62 keep the user's left leg separate from the user's right leg so that the user may seated in a comfortable and normal position for extended periods of time.

Additionally, the present invention may comprise a surface cover that removably encloses the present invention for comfort and aesthetic appeal. The surface cover may be attached to the present invention by simply sliding the surface covers over the present invention into place or by utilizing a fastening mechanism such as a zipper. The surface cover provides an easy cleaning system for the present invention as the surface cover can be removed and cleaned for sanitary purposes.

Traditionally, buttock augmentation patients place objects such as yoga mats, nursing pillows, normal head pillows, donut pillows, and yoga blocks underneath the surgery region of the buttocks in an attempt to relieve pressure while sitting normally. These methods result in an assortment of problems ranging from discomfort when sitting for extended periods of time to the buttocks sinking onto the seating surface. The present invention is viable and provides a superior alternative to conventional methods of sitting in a normal position while relieving pressure on the buttocks. The present invention is made from eco-friendly solid foam type materials or any other comfortable, light weight, and high strength materials so that the present invention does not deform or the user's legs don't sink into the top panel 6 while the user is sitting down.

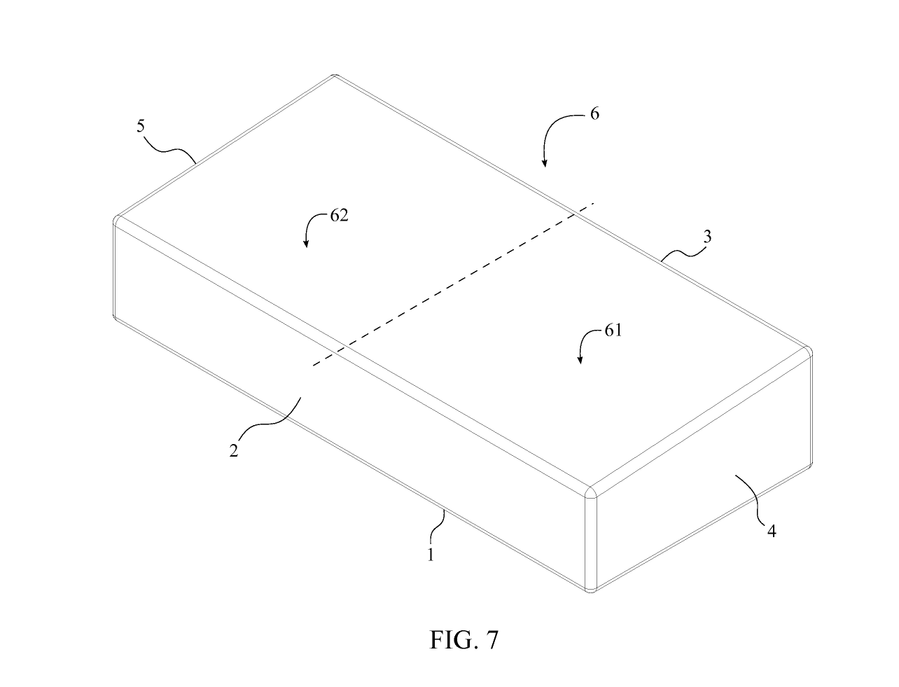

In reference to FIG. 7, alternative embodiment of the present invention may comprise a flat surface within the left leg section 61 and the right leg section 62. The flat surfaces of the left leg section 61 and the right leg section 62 provide a continuous linear surface, where the linear surface allows the user to move the user's legs side to side upon user's comfort and discretion.

Although the invention has been explained in relation to its preferred embodiment, it is to be understood that many other possible modifications and variations can be made without departing from the spirit and scope of the invention as hereinafter claimed.

1. A supporting pillow apparatus for relieving pressure on buttocks comprises:
a base panel;
a front wall;
a back wall;
a left lateral wall;
a right lateral wall;
a top panel;
a height for the front wall being positioned from the top panel to the base panel;
the height of the front wall being parallel to both the left lateral wall and the right lateral wall;
a height for the back wall being positioned from the top panel to the base panel opposite from the height of the front wall;
the height of the back wall being parallel to both the left lateral wall and the right lateral wall;
the height of the front wall being smaller than the height of the back wall height;
the front wall being perpendicularly connected with the base panel;
the back wall being perpendicularly connected with the base panel;
the back wall and the front wall being oppositely positioned from each other along the base panel;
the left lateral wall being perpendicularly connected with the base panel, the front wall, and the back wall;
the right lateral wall being perpendicularly connected with the base panel, the front wall, and the back wall;
the left lateral wall and the right lateral wall being oppositely positioned from each other across the base panel;
the top panel being perimetrically connected around the front wall, the left lateral wall, the back wall, and the right lateral wall; and
the top panel being oppositely positioned from the base panel.

2. (canceled)

3. (canceled)

4. (canceled)

5. The supporting pillow apparatus for relieving pressure on buttocks as claimed in claim 1 comprises:
the top panel comprises a left leg section and a right leg section;
the left leg section and the right leg section are adjacently positioned with each other;
the left leg section being adjacently positioned with the left lateral wall; and
the right leg section being adjacently positioned with the right lateral wall.

6. The supporting pillow apparatus for relieving pressure on buttocks as claimed in claim 5 comprises:
the left leg section and the right leg section each comprise a concave surface, an outer convex surface, and an inner convex surface;
the outer convex surface of the left leg section being adjacently positioned with the left lateral wall;
the concave surface of the left leg section being adjacently positioned with the outer convex surface of the left leg section;
the inner convex surface of the left leg section being adjacently positioned with the concave surface of the left leg section opposite from the outer convex surface of the left leg section;
the outer convex surface of the right leg section being adjacently positioned with the right lateral wall;
the concave surface of the right leg section being adjacently positioned with the outer convex surface of the right leg section;
the inner convex surface of the right leg section being adjacently positioned with the concave surface of the right leg section opposite from the outer convex surface of the right leg section; and
the inner convex surface of the right leg section and the left leg section being adjacently positioned with each other.

7. The supporting pillow apparatus for relieving pressure on buttocks as claimed in claim 5 comprises:
wherein the left leg section and the right leg section being a flat surface.

8. A supporting pillow apparatus for relieving pressure on buttocks comprises:
a base panel;
a front wall;
a back wall;
a left lateral wall;
a right lateral wall;
a top panel;
a height for the front wall being positioned in between the top panel and the base panel;
the height of the front wall being parallel to both the left lateral wall and the right lateral wall;
a height for the back wall being positioned in between the top panel and the base panel opposite from the front wall;
the height of the back wall being parallel to both the left lateral wall and the right lateral wall;
the height of the front wall being smaller than the height of back wall height;
the top panel comprises a left leg section and a right leg section;
the left leg section being adjacently positioned with the left lateral wall;
the right leg section being adjacently positioned with the right lateral wall;
the left leg section and the right leg section each comprise a concave surface, an outer convex surface, and an inner convex surface;
the outer convex surface of the left leg section being adjacently positioned with the left lateral wall;
the concave surface of the left leg section being adjacently positioned with the outer convex surface of the left leg section;
the inner convex surface of the left leg section being adjacently positioned with the concave surface of the left leg section opposite from the outer convex surface of the left leg portion;
the outer convex surface of the right leg section being adjacently positioned with the right lateral wall;
the concave surface of the right leg section being adjacently positioned with the outer convex surface of the right leg section;
the inner convex surface of the right leg section being adjacently positioned with the concave surface of the right leg section opposite from the outer convex surface of the right leg portion; and
the inner convex surface of the right leg section and the left leg section being adjacently positioned with each other.

9. The supporting pillow apparatus for relieving pressure on buttocks as claimed in claim 8 comprises:
the front wall being perpendicularly connected with the base panel;
the back wall being perpendicularly connected with the base panel; and
the front wall and the back wall being oppositely positioned from each other along the base panel.

10. The supporting pillow apparatus for relieving pressure on buttocks as claimed in claim 8 comprises:
the left lateral wall being perpendicularly connected with the base panel, front wall, and back wall;
the right lateral wall being perpendicularly connected with the base panel, front wall, and back wall; and
the left lateral wall and the right lateral wall being oppositely positioned from each other across the base panel.

11. The supporting pillow apparatus for relieving pressure on buttocks as claimed in claim 8 comprises:
the top panel being perimetrically connected around the front wall, the left lateral wall, the back wall, and the right lateral wall; and
the top panel being oppositely positioned from the base panel.

12. (canceled)

13. (canceled)

14. A supporting pillow apparatus for relieving pressure on buttocks comprises:
a base panel;
a front wall;
a back wall;
a left lateral wall;
a right lateral wall;
a top panel;
a height for the front wall being positioned in between the top panel and the base panel;
the height of the front wall being parallel to both the left lateral wall and the right lateral wall;
a height for the back wall being positioned in between the top panel and the base panel opposite from the front wall;
the height of the back wall being parallel to both the left lateral wall and the right lateral wall;
the height of the front wall being smaller than the height of back wall height;
the top panel comprises a left leg section and a right leg section;
the left leg section and the right leg section each comprise a concave surface, an outer convex surface, and an inner convex surface;
the left lateral wall being perpendicularly connected with the base panel, front wall, and back wall;
the right lateral wall being perpendicularly connected with the base panel, front wall, and back wall; and
the left lateral wall and the right lateral wall being oppositely positioned from each other across the base panel.

15. The supporting pillow apparatus for relieving pressure on buttocks as claimed in claim 14 comprises:
the front wall being perpendicularly connected with the base panel;
the back wall being perpendicularly connected with the base panel; and
the front wall and the back wall being oppositely positioned from each other along the base panel.

16. (canceled)

17. The supporting pillow apparatus for relieving pressure on buttocks as claimed in claim 14 comprises:
the top panel being perimetrically connected around the front wall, the left lateral wall, the back wall, and the right lateral wall; and
the top panel being oppositely positioned from the base panel.

18. The supporting pillow apparatus for relieving pressure on buttocks as claimed in claim 14 comprises:
the left leg section being adjacently positioned with the left lateral wall; and
the right leg section being adjacently positioned with the right lateral wall.

19. The supporting pillow apparatus for relieving pressure on buttocks as claimed in claim 14 comprises:
the outer convex surface of the left leg section being adjacently positioned with the left lateral wall;
the concave surface of the left leg section being adjacently positioned with the outer convex surface of the left leg section;
the inner convex surface of the left leg section being adjacently positioned with the concave surface of the left leg section opposite from the outer convex surface of the left leg portion;
the outer convex surface of the right leg section being adjacently positioned with the right lateral wall;
the concave surface of the right leg section being adjacently positioned with the outer convex surface of the right leg section;
the inner convex surface of the right leg section being adjacently positioned with the concave surface of the right leg section opposite from the outer convex surface of the right leg portion; and
the inner convex surface of the right leg section and the left leg section being adjacently positioned with each other.
